(19) United States
(12) Patent Application Publication
(10) Pub. No.: US 2010/0285716 A1
(43) Pub. Date: Nov. 11, 2010

(54) FABRICATION METHOD OF CARBON NANOTUBE FIELD EMISSION CATHODE

(75) Inventors: Borh-Ran Huang, Taipei City (TW); Tzu-Ching Lin, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/489,450

(22) Filed: Jun. 23, 2009

(30) Foreign Application Priority Data
May 8, 2009 (TW) 98115396

(51) Int. Cl. H01J 9/12

(52) U.S. Cl. 445/51

(57) ABSTRACT

A fabrication method of carbon nanotube field emission cathode is described as follows. Firstly, a composite plating solution including an electroless metal plating solution and a carbon nanotube powder disposed therein is provided. Then, a substrate is provided. The substrate is disposed in the composite plating solution so that an electroless composite plating process for forming a composite material layer on a surface of the substrate is performed. The composite material layer includes a carbon nanotube powder and a metal layer wrapping the carbon nanotube powder.

### CROSS-REFERENCE TO RELATED APPLICATION

This application claims the priority benefit of Taiwan application serial no. 98115396, filed on May 8, 2009. The entirety of the above-mentioned patent application is hereby incorporated by reference herein and made a part of specification.

### BACKGROUND OF THE INVENTION

1. Field of the Invention

The present invention relates to a fabrication method of a field emission backlight module, and more particularly to a fabrication method of a carbon nanotube field emission cathode.

2. Description of Related Art

In a thin film transistor (TFT) liquid crystal display (LCD), a backlight module generally adopts lamps (or light emitting diodes (LEDs)) as a light source and cooperates with multiple layers of optical thin films of different functions. However, costs of a light guide plate (LGP) and a brightness enhancement film (BEF) are high in the optical thin films. Moreover, when a light penetrates the optical thin films, about 40% of the light is lost so that a light emitting efficiency of the backlight module is lowered.

In order to improve the aforementioned problems, many researches switch to carbon nanotubes (CNTs) for a nano-field emission emitter of a self-luminescent incandescent light. The carbon nanotubes have a large height/width ratio which facilitates point discharge. Therefore, the carbon nanotubes emit electrons under a low driving voltage (Vₒₙ) and generate a high field emission current (Iₛₐₜ) so that the power consumption is reduced. In addition, as a carbon nanotube field emission backlight module does not require the incorporation of costly optical thin films (such as the LGP and the BEF) for the generation of uniform and sufficiently luminescent light, the fabricating cost is dramatically reduced. Since the field emission has high emission efficiency, high stability, low surface temperature, together with characteristics of low driving voltage and high current of the carbon nanotubes, the carbon nanotube field emission backlight module can be applied in the TFT-LCD.

FIG. 1 is a cross-sectional view illustrating a conventional carbon nanotube field emission backlight module. Referring to FIG. 1, in a conventional technique, a carbon nanotube 110 is formed on a conductive layer 120 and a fluorescent layer 130 is formed on an opposite conductive layer 140. Next, a voltage is applied to the conductive layer 120 and the opposite conductive layer 140, so that the conductive layer 120 and the carbon nanotube 110 are cathodes and the opposite conductive layer 140 is an anode. Consequently, the carbon nanotube 110 point discharges and electrons emitted by the carbon nanotube 110 collide with the fluorescent layer 130 to generate light.

Currently, fabrication methods of a carbon nanotube field emission cathode are mainly categorized into (1) direct deposition, (2) screen printing, (3) electrophoretic deposition, and (4) spray coating. In the direct deposition, a chemical vapor deposition (CVD) is performed for the synthesis. However, as CVD must be performed under high temperature (600° C.˜1100° C.), carbon nanotube field emission cathodes can not be formed in large areas due to the temperature constraint of a substrate. The screen printing has a low fabricating cost and a simple method. However, as a rubbing process is performed by using an organic solvent mixed with the carbon nanotubes, the carbon nanotubes are easily buried in the bottom layer of the organic solvent and a thermal annealing of 300° C.˜500° C. must be carried out for the carbon nanotubes to protrude the surface.

In the electrophoretic deposition, an electrochemical method is utilized to perform a carbon nanotube deposition process and the carbon nanotubes formed by the electrophoretic deposition are distributed uniformly. However, since the carbon nanotubes are disposed on the substrate by adsorption, the carbon nanotubes and the substrate have a poor adhesion and are easily separated so as to have a poor field emission characteristic. In the spray coating, a mixture of a surfactant and carbon nanotubes is used to perform the spray coating process through a spray gun of small diameter. Furthermore, the spray coating is similar to that of the electrophoretic deposition, where carbon nanotubes are merely adsorbed on the surface of the substrate. Hence, an indium (In) substrate with low melting point must be adopted for the deposition. The indium substrate is then heated so that the carbon nanotubes and the indium substrate are integrated to increase a viscosity thereof. However, the fabricating cost of this method is too high.

### SUMMARY OF THE INVENTION

A fabrication method of a carbon nanotube field emission cathode for fabricating the carbon nanotube field emission cathode under low temperature is provided in the present invention.

A fabrication method of a carbon nanotube field emission cathode provided in the present invention is illustrated in the following. Firstly, a composite plating solution including an electroless metal plating solution and a carbon nanotube powder is provided. The carbon nanotube powder is disposed in the electroless metal plating solution. Next, a substrate is provided. Afterwards, the substrate is disposed in the composite plating solution so that an electroless composite plating process is performed for forming a composite material layer on a surface of the substrate. The composite material layer comprises a carbon nanotube powder and a metal layer wrapping the carbon nanotube powder.

In one embodiment of the present invention, a fabricating temperature of the electroless composite plating process is 50° C.˜110° C.

In one embodiment of the present invention, a pH value of the electroless metal plating solution is 4˜7.

In one embodiment of the present invention, a pH value of the electroless metal plating solution is 5.4.

In one embodiment of the present invention, a fabricating time of the electroless composite plating process is 30 sec˜300 sec.

In one embodiment of the present invention, the electroless metal plating solution is an electroless nickel plating solution and a material of the metal layer includes nickel.

In one embodiment of the present invention, in the fabrication method of the carbon nanotube field emission cathode, a purification process is further performed to the carbon nanotube powder before the composite plating solution is provided. The purification process includes a thermal oxidation process, an acid purification process, and an acid oxidation process.

In one embodiment of the present invention, in the fabrication method of the carbon nanotube field emission cathode, a surface catalysis process is further performed before the electroless composite plating process is performed.

In one embodiment of the present invention, the composite plating solution further includes an aqueous surfactant.

In light of the foregoing, since the composite material layer is formed by using the electroless composite plating process in the present invention, a highly uniformed composite material layer (that is, the carbon nanotube field emission cathode) is formed in large areas under low temperature.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view illustrating a conventional carbon nanotube field emission backlight module.

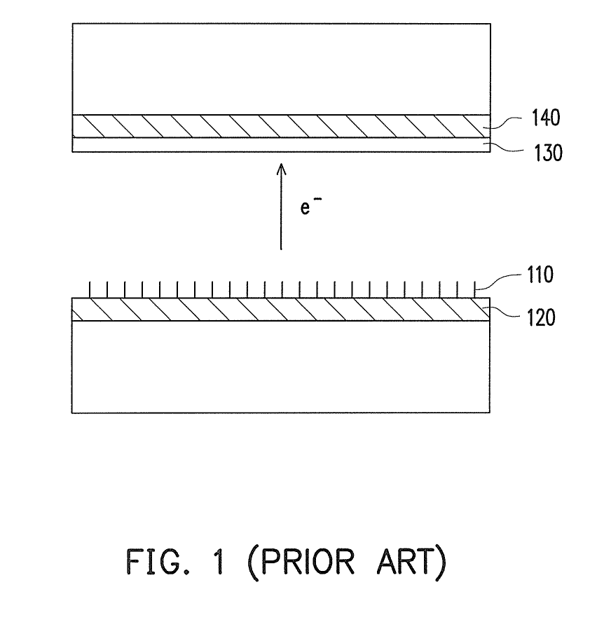

FIG. 2 is a fabrication process of a composite material layer according to an embodiment of the present invention.

FIG. 3 is a graph illustrating field emission measurements of the composite material layer (that is, the carbon nanotube field emission cathode) according to an embodiment of the present invention.

### DESCRIPTION OF EMBODIMENTS

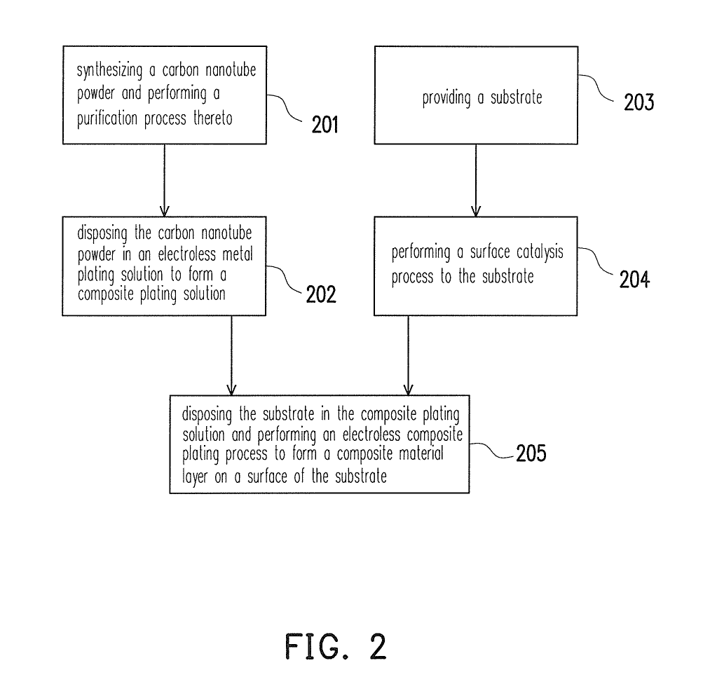

FIG. 2 is a fabrication process of a composite material layer according to an embodiment of the present invention.

Referring to FIG. 2, firstly, a carbon nanotube powder is synthesized and a purification process is performed thereto for removing impurities in the carbon nanotube powder (step 201). The purification process includes a thermal oxidation process, an acid purification process, and an acid oxidation process. In the thermal oxidation process, the carbon nanotube powder is disposed in an environment with oxygen or vapor and the carbon nanotube powder is heated to 300° C.˜800° C. for 5 min˜60 min. In the acid purification process, the carbon nanotube powder is disposed in a mixture of hydrochloric acid and nitric acid (with a volume ratio of 1:3) for an acid etching to be performed. Here, a fabricating time is 1 hr˜48 hr and a fabricating temperature is 70° C.˜110° C. In the acid oxidation process, the carbon nanotube powder is disposed in a mixture of sulfuric acid and nitric acid (with a volume ratio of 1:3) for an acid oxidation to be carried out. Here, a fabricating time is 1 hr˜48 hr and a fabricating temperature is 70° C.˜110° C.

Next, the carbon nanotube powder is disposed in an electroless metal plating solution to form a composite plating solution (step 202). In the present embodiment, the electroless metal plating solution is an electroless nickel plating solution. In other embodiments, the electroless metal plating solution is an electroless cobalt plating solution, an electroless palladium plating solution, an electroless platinum plating solution, an electroless copper plating solution, an electroless gold plating solution, an electroless silver plating solution, or other suitable electroless metal plating solutions. Moreover, in order for the carbon nanotube powder to be distributed in the electroless metal plating solution uniformly, an aqueous surfactant is added to the composite plating solution.

Furthermore, a substrate is provided (step 203), and a material thereof is glass, plastic, ceramics, or other suitable materials. Thereafter, a surface catalysis process is performed to the substrate (step 204) to facilitate the following electroless plating process. The surface catalysis process includes a cleansing, a sensitizing, and an activation of the surface of the substrate. In details, in the present embodiment, a cleansed substrate is soaked in a sensitizing solution (i.e. a mixture solution of tin dichloride and hydrochloric acid) for 30 min˜90 min. The substrate is subsequently disposed in an activating solution (i.e. a mixture solution of palladium chloride and hydrochloric acid).

Thereafter, the substrate is disposed in the composite plating solution so that an electroless composite plating process for forming a composite material layer on a surface of the substrate is performed (step 205). The composite material layer includes a carbon nanotube powder and a metal layer wrapping the carbon nanotube powder. The carbon nanotube powder is distributed within the metal layer and the composite material layer is the carbon nanotube field emission cathode. Moreover, a fabricating temperature of the electroless composite plating process is 50° C.˜110° C., for example.

It should be noted that in the present embodiment, the composite material layer is formed by using the electroless composite plating method. Therefore, a highly uniformed composite material layer can be formed in large areas under low temperature. In addition, the composite material layer and the substrate have a good adhesion, thereby enhancing the adhesion between the carbon nanotube powder and the substrate and the reliability of the field emission characteristic of the composite material layer. Besides, in the present embodiment, a thickness of the composite material layer is easily modified and the composite material layer can be formed on the insulating substrate (such as glass, plastic, ceramics) directly. Additionally, the present embodiment does not require the use of electroplating tank or the application of external voltage, thus has a low fabricating cost.

The pH value of the electroless metal plating solution is 4˜7, for instance. Here, the pH value of the electroless metal plating solution is substantially 5.4. The fabricating time of the electroless composite plating process is 30 sec˜300 sec, for example. In the present embodiment, the material of the metal layer includes nickel. In other embodiments, the material of the metal layer includes cobalt, palladium, platinum, copper, gold, silver, or other suitable conductive materials.

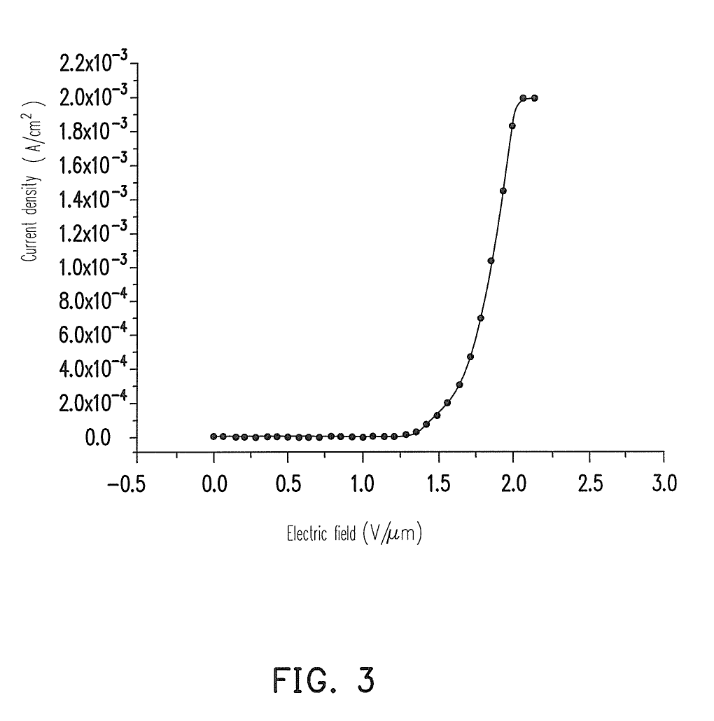

FIG. 3 is a graph illustrating field emission measurements of the composite material layer (that is, the carbon nanotube field emission cathode) according to an embodiment of the present invention. In the present embodiment, the pH value of the electroless metal plating solution is substantially 5.4. As shown in FIG. 3, a turn on field is 1.21 V/μm and a threshold field is 1.5 V/μm. In light of the aforementioned description, the composite material layer of the present embodiment has a good field emission characteristic.

In summary, in the present invention, the composite material layer is formed by using the electroless composite plating method. Hence, a highly uniformed composite material layer can be formed in large areas under low temperature. In addition, the composite material layer and the substrate have a good adhesion, thereby enhancing the adhesion between the carbon nanotube powder and the substrate and the reliability of the field emission characteristic of the composite material layer. Besides, in the present invention, the thickness of the composite material layer can be easily modified and the composite material layer can be formed on the insulating substrate directly.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A fabrication method of a carbon nanotube field emission cathode, comprising:
providing a composite plating solution including an electroless metal plating solution and a carbon nanotube powder, wherein the carbon nanotube powder is disposed in the electroless metal plating solution;
providing a substrate; and
disposing the substrate in the composite plating solution so that an electroless composite plating process for forming a composite material layer on a surface of the substrate is performed, wherein the composite material layer comprises a carbon nanotube powder and a metal layer wrapping the carbon nanotube powder.

2. The fabrication method of the carbon nanotube field emission cathode as claimed in claim 1, wherein a fabricating temperature of the electroless composite plating process is 50° C.˜110° C.

3. The fabrication method of the carbon nanotube field emission cathode as claimed in claim 1, wherein a pH value of the electroless metal plating solution is 4˜7.

4. The fabrication method of the carbon nanotube field emission cathode as claimed in claim 3, wherein a pH value of the electroless metal plating solution is 5.4.

5. The fabrication method of the carbon nanotube field emission cathode as claimed in claim 1, wherein a fabricating time of the electroless composite plating process is 30 sec˜300 sec.

6. The fabrication method of the carbon nanotube field emission cathode as claimed in claim 1, wherein the electroless metal plating solution is an electroless nickel plating solution and a material of the metal layer comprises nickel.

7. The fabrication method of the carbon nanotube field emission cathode as claimed in claim 1, further comprising:
before providing the composite plating solution, performing a purification process to the carbon nanotube powder, wherein the purification process comprises a thermal oxidation process, an acid purification process, and an acid oxidation process.

8. The fabrication method of the carbon nanotube field emission cathode as claimed in claim 1, further comprising:
before performing the electroless composite plating process, performing a surface catalysis process to the substrate.

9. The fabrication method of the carbon nanotube field emission cathode as claimed in claim 1, wherein the composite plating solution further comprises an aqueous surfactant.
